(19) United States
(12) Patent Application Publication
(10) Pub. No.: US 2004/0181367 A1
(43) Pub. Date: Sep. 16, 2004

(54) Diagnostic display

(76) Inventors: Minh H. Nguyen, Katy, TX (US); John Nguyen, Cypress, TX (US); Ghassan R. Gebara, Spring, TX (US); Robert Martinez, Houston, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/385,840

(22) Filed: Mar. 11, 2003

(51) Int. Cl. G06F 11/30; G06F 15/00

(52) U.S. Cl. 702/183

(57) ABSTRACT

A diagnostic system combines an electronic device with a plurality of status indicators that are visible to a user. A plurality of status indicators are arranged in a map representative of the physical location of components within the electronic device.

### BACKGROUND OF THE INVENTION

In some computer systems, light emitting diodes (LEDs) or other light indicators are used to indicate various conditions within the system, e.g. a malfunction of the system. For example, several LEDs are aligned along a front bezel of a system, and each LED has an adjacent icon, word or picture that is representative of the system component corresponding to that LED. However, such an approach can require a substantial amount of surface area for the LEDs and component pictures. Even if smaller icons are used, such an approach does not facilitate the locating of corresponding components within the system. In other systems, the status LEDs are placed proximate their corresponding electronic subcomponents, but such LEDs are easily obstructed with, for example, structural mechanical components.

### BRIEF DESCRIPTION OF THE DRAWINGS

Certain embodiments of the invention will hereafter be described with reference to the accompanying drawings, wherein like reference numerals denote like elements, and:

FIG. 1 is a front perspective view of an electronic device, according to embodiments of the present invention;

FIG. 2 is a top view of the device illustrated in FIG. 1 with a component cover removed according to embodiments of the present invention;

FIG. 3 is a top view of a plurality of status indicators illustrated in FIG. 1 according to embodiments of the present invention; and

FIG. 4 is an exploded, perspective view of a portion of the device illustrated in FIG. 1 according to embodiments of the present invention.

### DETAILED DESCRIPTION

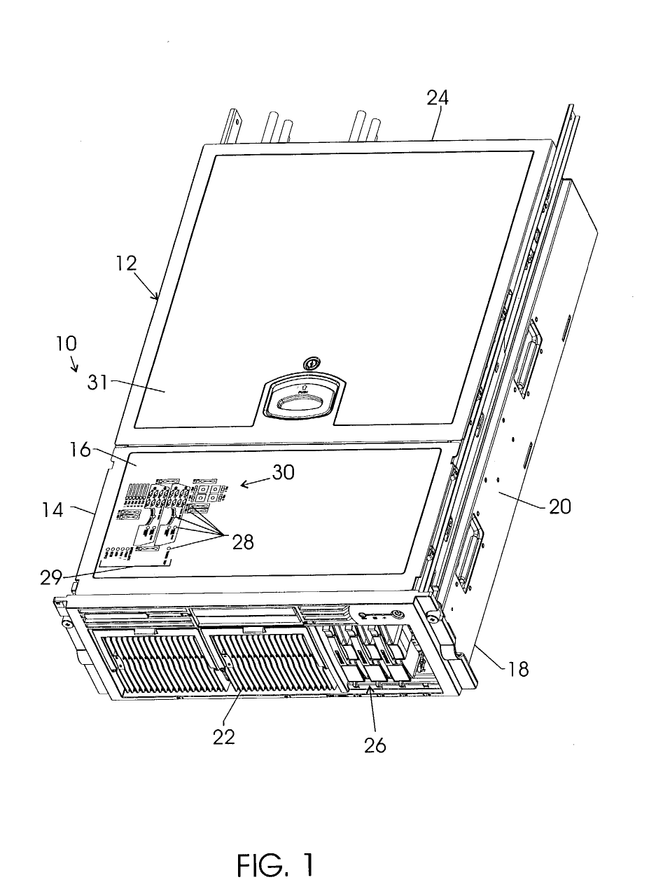

Referring generally to FIG. 1, a diagnostic system 10 is illustrated according to embodiments of the present invention. By way of example, diagnostic system 10 may comprise an electronic device 12, such as a server, personal computer or other computer-based device. Electronic device 12 may comprise a housing 14, such as an external housing, having a top 16, a bottom 18, a pair of sides 20, a front 22 and a rear 24.

The size, shape and configuration of housing 14 may vary according to application and according to the type of electronic device utilized in a given application or applications. For example, electronic device 12 may comprise a server having one or more drives 26 as well as a variety of other possible features. Regardless of the specific size, shape or configuration, electronic device 12 comprises a plurality of status indicators 28 disposed in a map 30 that is representative of the component layout in electronic device 12, as described in greater detail below.

Map 30 may be displayed at a variety of desired locations. For example, map 30 may be positioned along a visible portion 29 of housing 14. As illustrated in the embodiments of FIG. 1, map 30 may be deployed along top 16 in a readily viewable position.

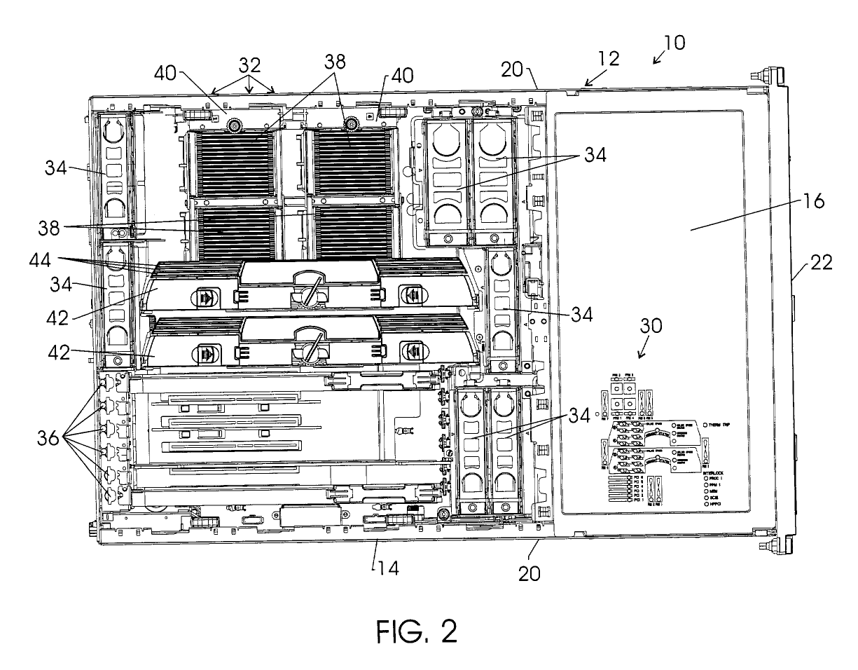

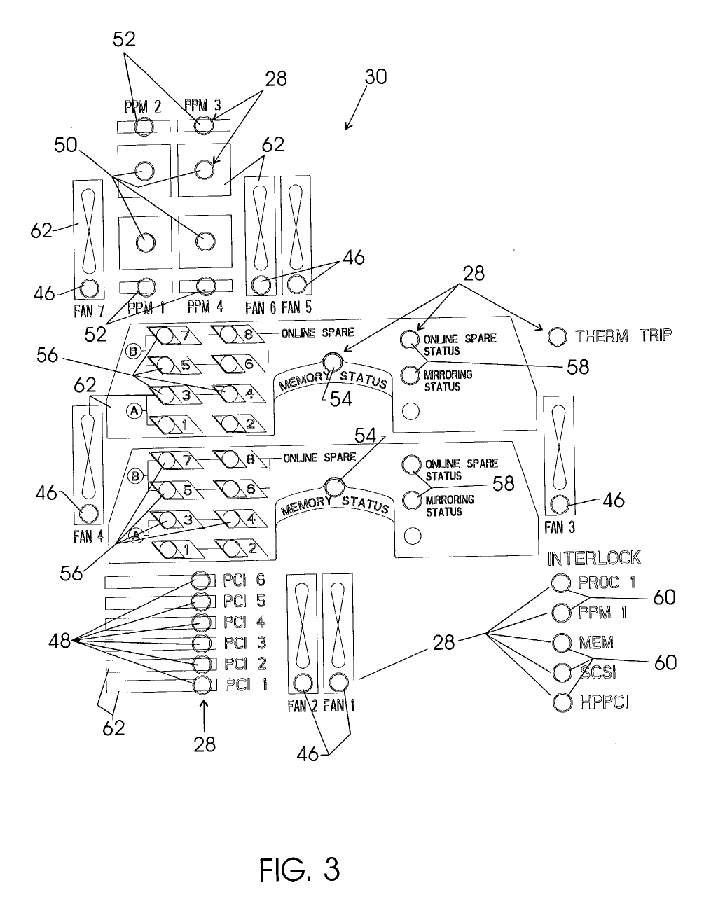

Referring generally to FIGS. 2 and 3, embodiments are illustrated in which components 32 are located within housing 14. As illustrated in FIG. 2, a cover 31 may be removed to reveal components 32 positioned within housing 14. Map 30 is provided in a convenient location, such as top 16, and is representative of the positioning of components 32. For example, device 12 may comprise a plurality of fans 34 disposed at specific locations within housing 14. At least one and often a plurality of peripheral component interface (PCI) slots 36 also may be included within device 12. Other examples of components may comprise processors 38 and processor power modules 40. Additional components may comprise at least one memory module 42 having a plurality of memory cards 44. In the embodiments illustrated, device 12 has a pair of memory modules 42. These are just of few examples of the potential components and component layouts that may be utilized in a given electronic device 12.

As illustrated best in FIG. 3, map 30 is constructed to correspond to the placement of components 32 associated with the electronic device 12, e.g., a computer-based device. For example, the plurality of status indicators 28 are arranged in a pattern representative of the physical location of the components 32 to which they correspond. By way of further example, fan status indicators 46 may be placed at locations within map 30 representative of the physical location of fans 34. Similarly, PCI status indicators 48 and processor indicators 50 may be positioned in map 30 to correspond to the location of PCI slots 36 and processors 38, respectively. Other specific status indicators, such as processor power module status indicators 52, memory status indicators 54 and memory card status indicators 56 may be positioned in map 30 to correspond to the physical location of processor power modules 40, memory modules 42 and memory cards 44, respectively.

Other status indicators 28 also can be incorporated into map 30 in a manner that corresponds to the operation of a specific component or components. For example, “ONLINE SPARE STATUS” indicators and “MIRRORING STATUS” indicators 58 correspond to certain operational functionalities of memory modules 42 and memory cards 44. A variety of other indicators 60 also can be incorporated into overall map 30, e.g. the “INTERLOCK” indicators illustrated in FIG. 3 and described in greater detail below. To further facilitate identification of the components to which indicators 28 correspond, a variety of symbols 62 may be placed around or proximate selected indicators 28. Symbols 62 may be representative of, for example, a fan, a memory card, a PCI slot, etc.

A variety of status indicators may be utilized, including mechanical indicators, audible indicators, visual indicators and various combinations of indicators. In some embodiments, however, lights or lighted indicators are utilized to represent a given status of the component to which the specific indicator corresponds. Additionally, a variety of light colors may be utilized for aesthetic reasons or to emphasize a specific status. Generally, the status indicator changes state, e.g. changes from unlit to lighted or blinking, to indicate a given status change in a component.

In some embodiments, for example, status indicators 28 are lights, such as light emitting diodes (LEDs) that are lit to indicate a problem. When a component is operating normally, the status indicator remains unlit. Upon detection of a failure, however, the status indicator is lighted to indicate the component failure to a user. For example, lighting of a fan status indicator 46 would represent detection of a failure of the component fan 34 that corresponds to the specific status indicator. This same approach can be used to indicate detection of a failure in any one or more of the PCI status indicators 48, processor status indicators 50, processor power module status indicators 52, memory status indicators 54, memory card status indicators 56, etc.

LEDs or other types of status indicators 28 also may be used to indicate a status other than component failure. For example, illumination of various interlock indicators 60 may be used to provide desired information regarding status of a system or component. For example, illumination of the status indicator 60 marked “PROC 1” in FIG. 3 may be used to indicate that a specific processor is not installed properly; illumination of the status indicator 60 marked “PPM 1” may be used to indicate that a processor power module is not installed properly; illumination of the status indicator 60 marked “MEM” may be used to indicate that no memory boards are detected or a memory board is installed improperly; illumination of the status indicator 60 marked “SCSI” may be used to indicate that the Small Computer System Interface backplane is not seated properly; and illumination of the status indicator 60 marked “HPPCI” may be used to indicate a PCI hot plug peripheral component array cable or peripheral component interface-x hot plug board is not installed properly. These are just a few examples of the functionality and arrangements of status indicators within map 30.

Regardless of the specific type of corresponding components 32 and indicators 28, use of map 30 allows a technician to quickly locate the component of interest within electronic device 12. The technician simply views map 30 and the location of a given indicator within map 30. That map location corresponds to the physical location of the subject component and facilitates locating of the subject component within housing 14. For example, if a status indicator 28 is lit or otherwise indicating a component problem, map 30 is used to quickly guide the technician to the subject component.

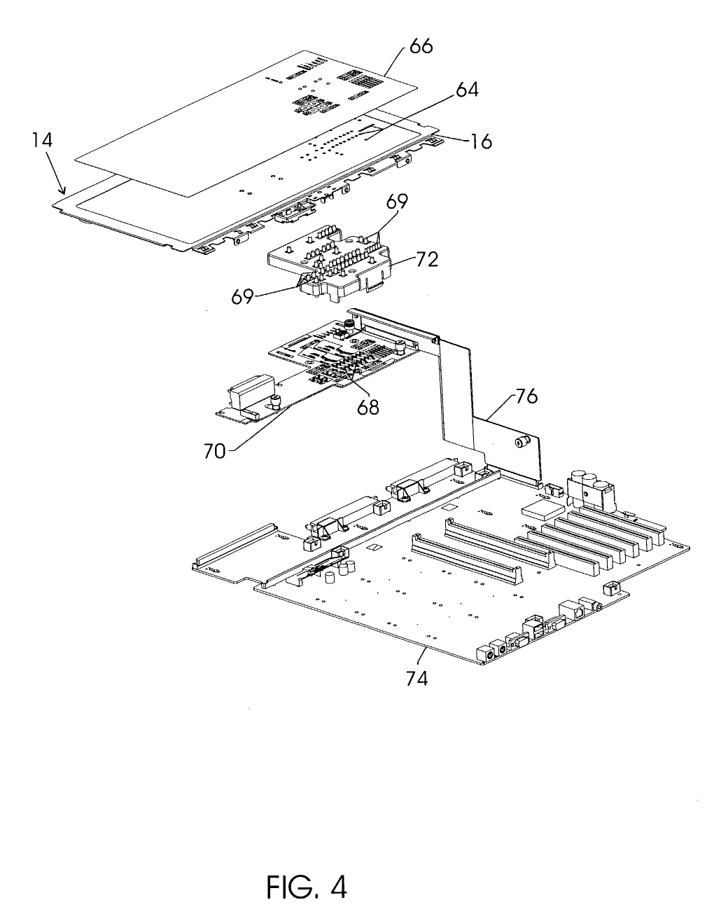

Although status indicators 28 may be formed in a variety of ways, some embodiments utilize a plurality of windows 64 created by forming holes through housing 14, such as through top 16 as illustrated in FIG. 4. Symbols 62 or other markings may be formed either directly on chassis 14, or they may be printed or otherwise formed on a sheet 66 applied to chassis 14 over windows 64. An exemplary sheet may comprise a plastic sheet adhered to the housing. For example, sheet 66 may be formed of Lexan®, a material available from GE Corporation, and the component symbols or other markings may be printed on the material.

Light may be directed through specific windows 64 via appropriate lights, such as LEDs 68. The LEDs 68 may be positioned directly below windows 64 or at a distance from windows 64 such that light is directed to the appropriate windows. For example, a plurality of light pipes 69 may be positioned between LEDs 68 and windows 64 to transmit light from LEDs 68 to the openings through housing 14 that form windows 64. In some embodiments, LEDs 68 may be arranged on a removable media board 70 in the same pattern as windows 64, and light pipes 69 may be positioned in a light pipe tree 72 positioned between media board 70 and top 16 of housing 14. Also, media board 70 may be coupled to other boards, such as a system board 74, via an appropriate pass-through board or cable 76.

While the invention may be susceptible to various modifications and alternative forms, specific embodiments have been shown by way of example in the drawings and described in detail herein. However, it should be understood that the invention is not intended to be limited to the particular forms disclosed.

What is claimed is:

1. A diagnostic system, comprising:
a computer-based device having an external housing; and
a plurality of status indicators visible at a desired location of the external housing to indicate the status of corresponding components, wherein the plurality of status indicators are arranged in a map representative of the physical location of the corresponding components in the computer-based device.

2. The diagnostic system as recited in claim 1, wherein the computer-based device comprises a server.

3. The diagnostic system as recited in claim 1, wherein the plurality of status indicators comprises light emitting diodes (LEDs).

4. The diagnostic system as recited in claim 3, wherein the plurality of status indicators comprises windows disposed in the external housing and arranged in the map.

5. The diagnostic system as recited in claim 4, wherein the LEDs are operatively coupled to the windows via a plurality of light pipes.

6. The diagnostic system as recited in claim 1, wherein the external housing comprises a front and a top, the plurality of status indicators being visible through the top.

7. A diagnostic system, comprising:
an electronic device having: a plurality of components, a map indicative of each component location of the plurality of components, and a plurality of visual indicators positioned on the map to provide status information relevant to changes in status of an individual component.

8. The diagnostic system as recited in claim 7, wherein the electronic device is a computer-based device.

9. The diagnostic system as recited in claim 7, wherein the electronic device is a server.

10. The diagnostic system as recited in claim 7, wherein the plurality of visual indicators provides status information via light.

11. The diagnostic system as recited in claim 7, wherein the light is provided by a plurality of LEDs.

12. The diagnostic system as recited in claim 11, wherein the electronic device comprises a housing having openings through which light passes from the LEDs.

13. The diagnostic system as recited in claim 12, wherein the LEDs are operatively coupled to the openings by a plurality of light pipes.

14. The diagnostic system as recited in claim 7, wherein the plurality of visual indicators provides an indication of component malfunction.

15. A method, comprising:
placing a plurality of components within a housing to form a computer-based device; and
arranging a plurality of component status indicators along a portion of the housing in a configuration representative of the arrangement of the plurality of components.

16. The method as recited in claim 15, wherein placing comprises locating the plurality of components within a server housing.

17. The method as recited in claim 15, wherein arranging comprises arranging a plurality of lights along a top of the housing.

18. The method as recited in claim 15, wherein arranging comprises forming a plurality of windows in the portion of the housing.

19. The method as recited in claim 15, wherein arranging comprises forming a plurality of windows in a top panel of the housing.

20. The method as recited in claim 19, further comprising coupling LEDs to the plurality of windows via light pipes.

21. A system, comprising:
means for enclosing a plurality of components in a computer-based device; and
means for arranging lightable status indicators in a map corresponding to an arrangement of the plurality of components.

22. The system as recited in claim 21, wherein the means for enclosing comprises a server housing.

23. The system as recited in claim 21, wherein the means for arranging comprises a plurality of windows arranged in a representative pattern in a housing.
